(19) United States
(12) Patent Application Publication
(10) Pub. No.: US 2013/0163925 A1
(43) Pub. Date: Jun. 27, 2013

(54) OPTICAL FIBER COUPLER AND INSERTION PORT

(71) Applicant: KAI-WEN WU, Tu-Cheng (TW)

(72) Inventor: KAI-WEN WU, Tu-Cheng (TW)

(73) Assignee: HON HAI PRECISION INDUSTRY CO., LTD., Tu-Cheng (TW)

(21) Appl. No.: 13/550,793

(22) Filed: Jul. 17, 2012

(30) Foreign Application Priority Data
Dec. 27, 2011 (TW) 100148788

(51) Int. Cl. G02B 6/32

(52) U.S. Cl. 385/33

(57) ABSTRACT

An optical fiber coupler includes two insertion ports inserted into each other. Each insertion port includes a main body having a connecting wall, at least two lenses positioned adjacent to the connecting wall, and at least two optical fibers coupled with the at least two lenses. While the connecting wall has an axis of symmetry, one insertion port acts as a male port, and the other insertion port acts as a female port. A positioning post protrudes from the connecting wall. A guiding hole is formed on the connecting wall. The projections of the positioning post and the guiding hole on the connecting wall are symmetrical around the longitudinal center axis of the optical fiber coupler, respectively. The lenses are symmetrical around the longitudinal center of axis.

### BACKGROUND

1. Technical Field

The present disclosure relates generally to optical fiber coupler, especially to an optical fiber coupler having one or more insertion port.

2. Description of Related Art

Optical fiber couplers may be used in an electronic device for transmitting data. A common optical fiber coupler includes a male port and a female port. In use, the male port of one optical fiber coupler is inserted into the female port of another optical fiber coupler, and the lenses of the male port are aligned with the lenses of the female port, thus an optical signal may be transmitted between the female port and the male port. The male port forms a conical frustum positioning portion, and the female port defines a conical frustum positioning hole corresponding to the positioning portion of the male port, to make sure all the lenses are precisely aligned. The sizes of the positioning portion and the positioning hole must be precise. However, the structures of the female port and the male port are different. Two different molds are needed to be designed for fabricating the female port and the male port of the optical fiber coupler. Thus, research and manufacturing cost of molds is unduly increased.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of one embodiment of an optical fiber coupler including two insertion ports.

FIG. 2 is an isometric view of the insertion port of the optical fiber coupler of FIG. 1.

FIG. 3 is an enlarged, isometric view of circled portion III of FIG. 2.

FIG. 4 is a sectional view of the insertion port shown in FIG. 2.

### DETAILED DESCRIPTION

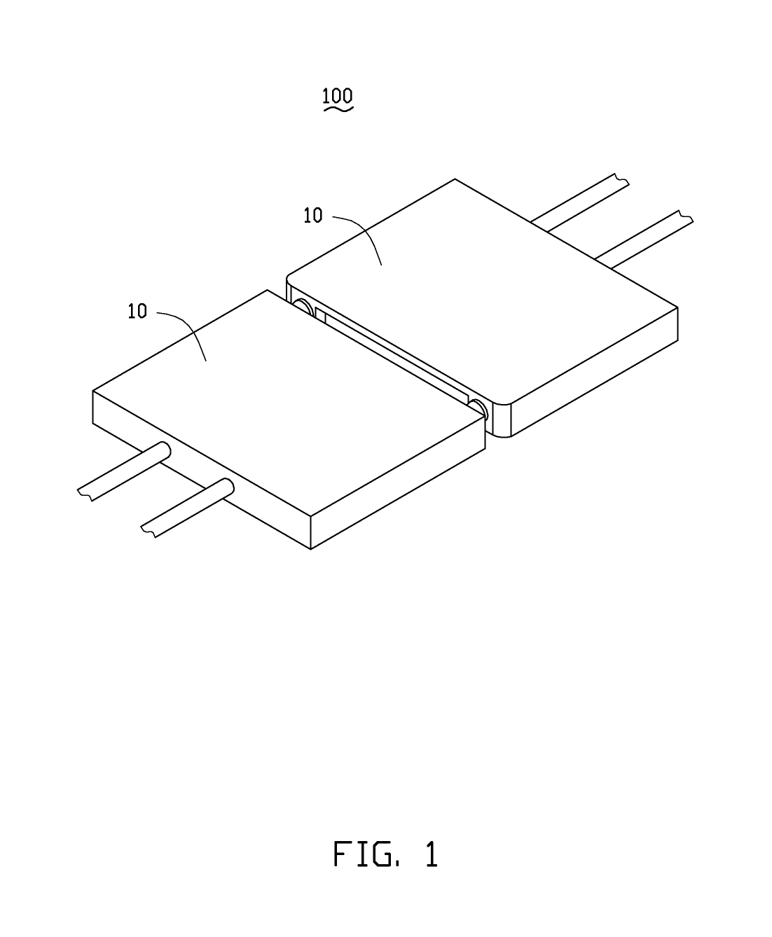

FIG. 1 is an isometric view of one embodiment of an optical fiber coupler 100 including two insertion ports 10 coupling each other. One insertion port 10 is a female port as mounted in an electronic device (not shown in FIG. 1), such as a computer, a printer, or a camera, for example. Another insertion port 10 is a male port which is portable; that is, the male port is brought to the female port, and may be coupled with the insertion port 10 (the female port) which is mounted on the electronic device to transmit data from one electronic device to another electronic device.

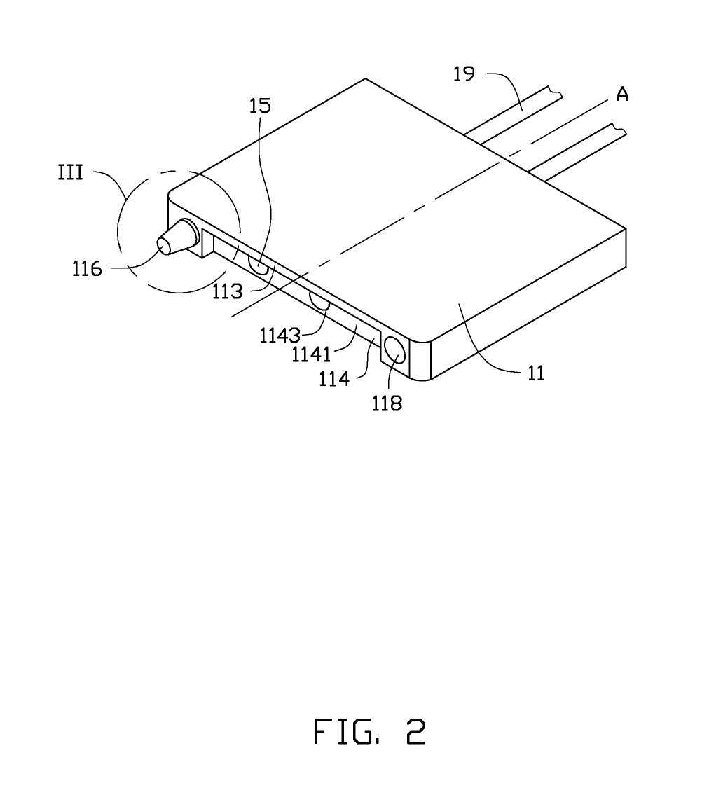

Also referring to FIG. 2, the insertion port 10 includes a main body 11, a pair of lenses 15, and a pair of optical fibers 19.

The main body 11 is a substantially rectangular plate that is symmetrical around an axis A. The main body 11 includes a connecting wall 113. The main body 11 defines a receiving groove 114 on the connecting wall 113. The bottom of the receiving groove 114 forms a transmission surface 1141. An axis of symmetry of the receiving groove 114 and the transmission surface 1141 is adjacent to the axis A. The main body 11 further defines a pair of receiving holes 1143 symmetrically arranged around the symmetry axis A on the transmission surface 1141 to receive the lenses 15.

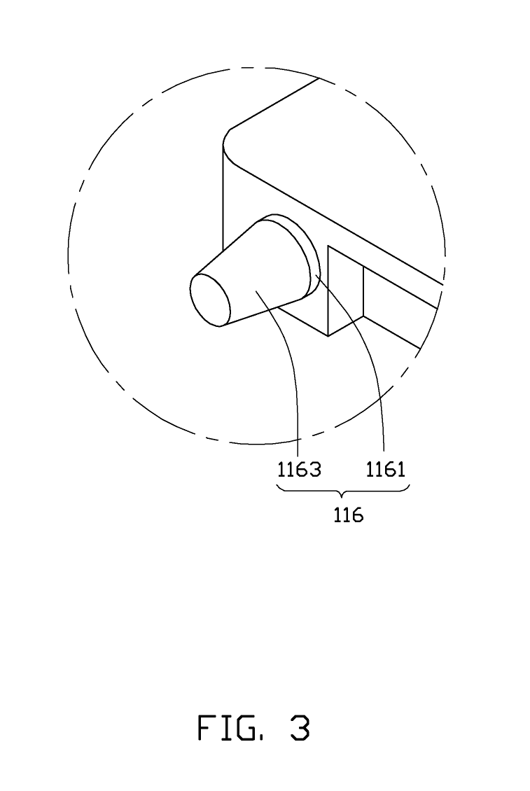

Referring to FIG. 3, a positioning post 116 perpendicularly protrudes from one end of the connecting wall 113, at adjacent to the receiving groove 114. In the illustrated embodiment, the positioning post 116 includes a first positioning body 1161 and a second positioning body 1163 connecting with the first positioning body 1161. The first positioning body 1161 is substantially cylindrical, located between the connecting wall 113 and the second positioning body 1163. The second positioning body 1163 is substantially conical. The diameter of the second positioning body 1163 gradually decreases from one end of the second positioning body 1163 adjacent to the first positioning body 1161 to the other end of the second positioning body 1163.

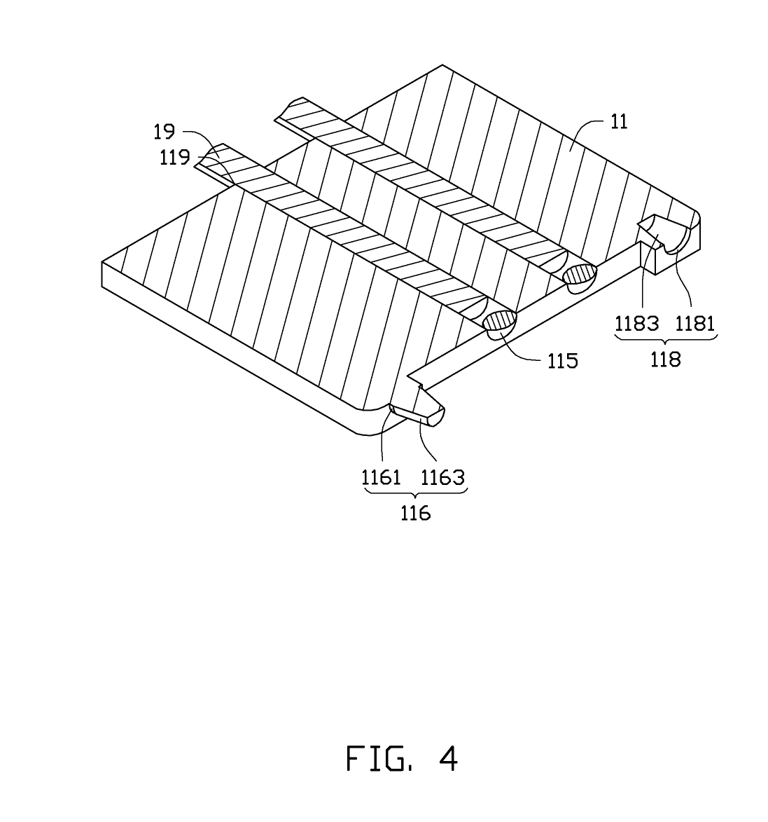

Also referring to the FIG. 4, the main body 11 defines a guiding hole 118 on another end of the connecting wall 113 opposite to the positioning post 116. The guiding hole 118 and a projection of the positioning post 116 on the connecting wall 113 are aligned with, and equidistant from, the symmetry axis A. The receiving groove 114 is located between the positioning post 116 and the guiding hole 118. The shape and the structure of the guiding hole 118 substantially match those of the positioning post 116. In the illustrated embodiment, the guiding hole 118 includes a first guiding section 1181 and a second guiding section 1183 connecting with the first guiding section 1181. The first guiding section 1181 is a substantially cylindrical hole located adjacent to the connecting wall 113, and extending inside of the main body 11. The second guiding section 1183 is substantially conical hole and connects an end of the first guiding section 1181 away from the connecting wall 113. The diameter of the second guiding section 1183 gradually decreases from the outside portion of the second guiding section 1183 connecting with the first guiding section 1181 to the inside portion thereof. Two connecting holes 119 are defined on one side surface of the main body 11 opposite to the connecting wall 113. Each connecting hole 119 communicates with the one receiving hole 1143.

A lens 15 is received in each of the two receiving holes 1143. A portion of each lens 15 is exposed out of each receiving hole 1143 relative to the transmission surface 1141.

Two optical fibers 19 are passed through the two connecting holes 119, in which each optical fiber 19 aligns with a lens 15.

In other embodiments, the number of the receiving holes 1143 is at least two, and there are corresponding numbers of the lenses 15, the connecting holes 119, and the optical fibers 19, respectively. The at least two lenses 15 are received in the at least two receiving holes 1143. The at least two optical fibers 19 are passed through the connecting holes 119, and coupled with the at least two lenses 15.

In use, one insertion port 10 which acts as the male port is engaged with the another insertion port 10 which acts as the female port. The positioning post 116 of one insertion port 10 acts as a male port for insertion into the guiding hole 118 of another insertion port 10 acting as the female port. Meanwhile at the same time, the positioning post 116 of the insertion port 10 which is acting as the female port is inserted into the guiding hole 118 of the insertion port 10 which is acting as the male port. The lenses 15 of the two insertion ports 10 are aligned.

Each insertion port 10 carries a male port and a female port. Therefore, only one mold needs to be designed and made, because a single molded product of the optical fiber coupler is able to function both as a male port and a female port for providing reliable and precise connector functionality required of a optical fiber coupler. The coupling accuracy is thereby improved. Furthermore, the cost and time of designing and manufacture of the optical fiber coupler is reduced.

It is believed that the present embodiments and their advantages will be understood from the foregoing description, and it will be apparent that various changes may be made thereto without departing from the spirit and scope of the disclosure or sacrificing all of its material advantages.

What is claimed is:

1. An optical fiber coupler, comprising:
two insertion ports, each insertion port comprising:
a main body having a connecting wall, and the connecting wall having a symmetry axis;
at least two lenses positioned on the connecting wall;
at least two optical fibers optical coupled with the at least two lenses, respectively;
wherein one insertion port act as a male port, and another insertion port act as a female port mounted in an electronic device; a positioning post protrudes from the connecting wall, a guiding hole is formed on the connecting wall, the projections of the positioning post and the guiding hole on the connecting wall are symmetrical relative to the symmetry axis, the at least two lenses are also symmetrical relative to the symmetry axis and positioned in between the positioning post and the guiding hole; one positioning post of one insertion port is capable of engaging with one guiding hole of another insertion port.

2. The optical fiber coupler of claim 1, wherein the positioning post comprises a first positioning body connecting with the connecting wall, the guiding hole comprises a first guiding section connecting with the connecting wall, the first positioning body matches the first guiding section.

3. The optical fiber coupler of claim 2, wherein the first positioning body is a cylinder, the first guiding section is a substantially cylindrical hole corresponding to the first positioning body.

4. The optical fiber coupler of claim 2, wherein the positioning post comprises a second positioning body connecting with the first positioning body away from the connecting wall, the guiding hole comprises a second guiding section connecting with first guiding section away from the connecting wall, the second positioning body matches the second guiding section.

5. The optical fiber coupler of claim 4, wherein the second positioning body is a cone, and the second guiding section is a substantially conical hole corresponding to the second positioning body.

6. The optical fiber coupler of claim 5, wherein a diameter of a first end of the second positioning body away from the first positioning body is less than that of a second end of the second positioning body adjacent to the first positioning body.

7. The optical fiber coupler of claim 1, wherein a receiving groove is defined on the connecting wall between the positioning post and the guiding hole, the at least two lenses are positioned on a transmission surface at the bottom of the receiving groove.

8. The optical fiber coupler of claim 7, wherein the at least two receiving holes are defined on the transmission surface of the receiving groove, the at least two lenses are received in the at least two receiving holes respectively.

9. The optical fiber coupler of claim 8, wherein a portion of the lenses protrudes from the receiving hole.

10. The optical fiber coupler of claim 8, wherein at least two connecting holes are defined on a side surface of the main body away from the connecting wall, the at least two connecting holes communicates with the receiving holes, the at least two optic fibers pass through the at least two connecting holes.

11. An insertion port comprising:
a main body having a connecting wall, and the connecting wall having a symmetry axis;
at least two lenses positioned on the connecting wall;
at least two optical fibers optical coupled with the at least two lenses;
wherein a positioning post protrudes from the connecting wall, a guiding hole is formed on the connecting wall, the projections of the positioning post and the guiding hole on the connecting wall are symmetrical relative to the symmetry axis, the at least two lenses are also symmetrical relative to the symmetry axis and positioned in between the positioning post and the guiding hole.

12. The insertion port of claim 11, wherein the positioning post comprises a first positioning body connecting with the connecting wall, the guiding hole comprises a first guiding section connecting with the connecting wall, and the first positioning body matches the first guiding section.

13. The insertion port of claim 12, wherein the first positioning body is a cylinder, the first guiding section is a substantially cylindrical hole corresponding to the first positioning body.

14. The insertion port of claim 12, wherein the positioning post comprises a second positioning body connecting with the first positioning body away from the connecting wall, the guiding hole comprises a second guiding section connecting with the first guiding section away from the connecting wall, the second positioning body matches the second guiding section.

15. The insertion port of claim 14, wherein the second positioning body is a cone, the second guiding section is a conical hole corresponding to the second positioning body.

16. The insertion port of claim 15, wherein a diameter of a first end of the second positioning body away from the first positioning body is less than that of a second end of the second positioning body adjacent to the first positioning body.

17. The insertion port of claim 16, wherein a receiving groove is defined on the connecting wall between the positioning post and the guiding hole, the at least two lenses are positioned on a bottom surface of the receiving groove.

18. The insertion port of claim 17, wherein the at least two receiving holes are defined on the bottom surface of the receiving groove, the at least two lenses are received in the at least two receiving holes, respectively.

19. The insertion port of claim 18, wherein a portion of the lenses protrude from the receiving hole.

20. The insertion port of claim 18, wherein at least two connecting holes are defined on a side surface of the main body away from the connecting wall, the at least two connecting holes communicates with the receiving holes, the at least two optic fibers pass through the at least two connecting holes.
